(19) United States
(12) Patent Application Publication
(10) Pub. No.: US 2018/0052506 A1
(43) Pub. Date: Feb. 22, 2018

(54) VOLTAGE AND FREQUENCY SCALING APPARATUS, SYSTEM ON CHIP AND VOLTAGE AND FREQUENCY SCALING METHOD

(71) Applicant: REALTEK SEMICONDUCTOR CORP., HSINCHU (TW)

(72) Inventors: Chun-Yi KUO, Taipei City (TW); Ying-Yen CHEN, Chiayi County (TW); Hsin-Chang LIN, Hsinchu County (TW); Jih-Nung LEE, Hsinchu County (TW)

(21) Appl. No.: 15/679,786

(22) Filed: Aug. 17, 2017

(30) Foreign Application Priority Data
Aug. 18, 2016 (TW) 105126458

(51) Int. Cl. G06F 1/32; G06F 11/28; G05F 1/26; G05F 1/46

(52) U.S. Cl. CPC G06F 1/3206; G06F 1/324; G05F 1/463; G06F 11/28; G05F 1/26; G06F 1/3296

(57) ABSTRACT

A voltage and frequency scaling apparatus includes a processor, at least one sensor and a controller. The at least one sensor is electrically coupled to the processor. The at least one sensor measures at least one device characteristic of at least one logic circuit of a system on chip, and transmits at least one sensing result to the processor. The processor generates a control signal according to the at least one sensing result. The controller receives the control signal and adjusts at least one of the operating frequency and the operating voltage of at least one logic circuit. Furthermore, a system on chip (SoC) and a voltage and frequency scaling method are also described herein.

### CROSS-REFERENCE TO RELATED APPLICATION

This application claims the benefit of Taiwan Patent Application No. 105126458, filed Aug. 18, 2016 at the Taiwan Intellectual Property Office, the disclosure of which is incorporated herein in its entirety by reference.

### BACKGROUND OF THE INVENTION

### 1. Field of the Invention

The present disclosure relates to a system power management, especially a management of the operating voltage and frequency of the system on chip (SoC) and the relevant voltage and frequency scaling apparatus and method thereof.

### 2. Description of the Related Art

The dynamic voltage and frequency scaling (DVFS) technology is a power supply management technology implemented in computer architecture. DVFS technology can increase or reduce the power supply voltage based on operation requirements. Electricity consumption can be reduced by lowering the voltage, which is particularly relevant for laptop computers and mobile devices, whereas processing performance of such chips is enhanced when the voltage is increased. In addition, under some circumstances, lowering the voltage can also increase the overall system reliability of the electronic device.

Traditional DVFS technology may be implemented through application programs in the processors. However, chip performance as estimated at the design stage does not match actual performance. Traditional DVFS technology solely employs software methods and is unable to determine the most suitable operating voltage/frequency values based on the performance of the processor during its actual operations, resulting in a lower system performance of the electronic device.

### SUMMARY OF THE INVENTION

Based on an embodiment of the present disclosure, a voltage and frequency scaling apparatus comprises a processor, at least one sensor and a controller. The at least one sensor is electrically coupled to the processor. The at least one sensor is configured for measuring at least one device characteristic of at least one logic circuit of a system on chip and outputs at least one sensing result to the processor. The processor generates a control signal based on the at least one sensing result. The controller is configured to receive the control signal and adjust at least one of the operating frequency and the operating voltage of at least one logic circuit based on at least the control signal.

Based on an embodiment of the present disclosure, the present disclosure also discloses a system on chip (SoC) comprising at least one logic circuit, at least one sensor, and a processor. The at least one sensor measures at least one device characteristic of the at least one logic circuit and outputs at least one sensing result. The processor is electrically coupled to at least one sensor. The processor is configured for adjusting at least one of the operating frequency and the operating voltage of the at least one logic circuit based on the at least one sensing result.

Based on an embodiment of the present disclosure, the present disclosure further discloses a voltage and frequency scaling method for scaling the voltage and/or frequency of the at least one logic circuit of the system on chip. The voltage and frequency scaling method comprises receiving at least one sensing result of at least one device characteristic corresponding to the at least one logic circuit, and generating the control signal based on the at least one sensing result for controlling at least one of the operating frequency and the operating voltage of the at least one logic circuit.

Based on one or several aforementioned embodiments, through the use of a sensor to measure the actual operation performance of the logic circuit integrated into the system on chip, the controller can select at least one of the most suitable operating frequency and operating voltage based on the actual operation performance of the logic circuit in order to optimize the performance of the chip.

### BRIEF DESCRIPTION OF THE DRAWINGS

FIG. 1 is a block diagram of the relevant architecture of the dynamic voltage and frequency scaling technology of the present disclosure.

FIG. 2 is a schematic diagram of a system on chip of one embodiment of the present disclosure comprising a voltage and frequency scaling apparatus.

FIG. 3 is a schematic diagram of a system on chip of another embodiment of the present disclosure comprising a voltage and frequency scaling apparatus.

FIG. 4 is a schematic diagram of a system on chip and a voltage and frequency scaling apparatus of one embodiment of the present disclosure.

FIG. 5 shows details of an implementation of a system on chip based on the voltage and frequency scaling apparatuses of the embodiments of the present disclosure as illustrated in FIGS. 2 to 4.

FIG. 6 is an example of a predetermined look-up table of the embodiment illustrated in FIG. 5.

FIG. 7 is a flow chart of a voltage and frequency scaling method of one embodiment of the present disclosure.

### DESCRIPTION OF THE PREFERRED EMBODIMENTS

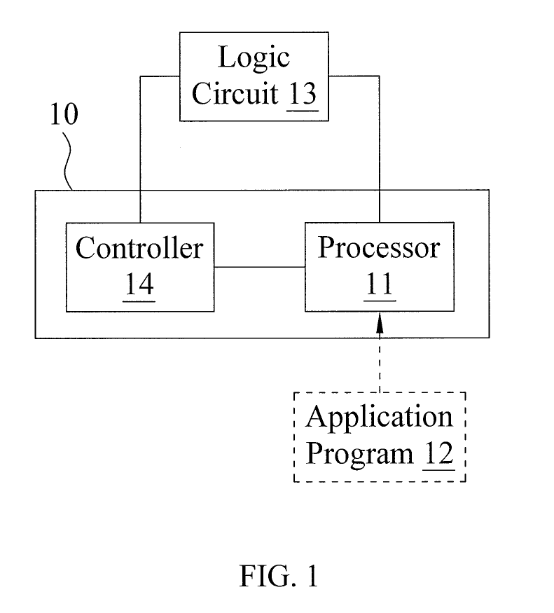

FIG. 1 is a block diagram of the relevant architecture of the dynamic voltage and frequency scaling (DVFS) technology of the present disclosure. As shown in FIG. 1, within a DVFS architecture 10, a processor 11 can monitor through an application program 12 the operation status of the logic circuit 13, which could be, for example, a chip with certain functions, and further adjust the operating voltage/frequency of the logic circuit 13 through the controller 14.

However, simply relying on the application program 12 will not provide the most suitable voltage/frequency range with regards to the actual operation performance of the chip, since the performance of the chip in actual operation is different from the performance of the chip as estimated at the design stage. In actual operation, the performance of the chip is affected by several factors, such as process variation and its ambient temperature. Particularly in an advanced manufacturing process (such as in the case of 28 nanometers or less than 20 nanometers), process variation causes the significant observed disparity between chip performance in actual operation and the performance as estimated at the design and manufacturing stage. For example, during the manufacturing process of a set of chips, the transistor channel length and the thickness of the semiconductor in each chip can not be the same, as this would result in more or less saturation current in the transistor than required. Therefore, following manufacture of a set of chips, the power consumption and performance speed of each chip of the same set is different. When simply relying on the application program 12 to determine the operation range of the chip, chips of different speeds are controlled by an identical range, and so chip performance can not be optimized.

In addition, in a complex system, different component parts also contribute different specific levels of impact to the chip, causing, for example, IR drop or voltage drop. For instance, a system on chip (SoC) may include a plurality of logic circuits 13. These logic circuits 13 may affect each other, causing the performance of these logic circuits 13 to drop from the expected performance thereof as estimated in the design and manufacturing stage. Therefore, for these reasons, simply relying on the software method (such as the application program 12) will not determine and enable the most suitable operating voltage/frequency range of the chip (such as of the logic circuit 13) to be employed.

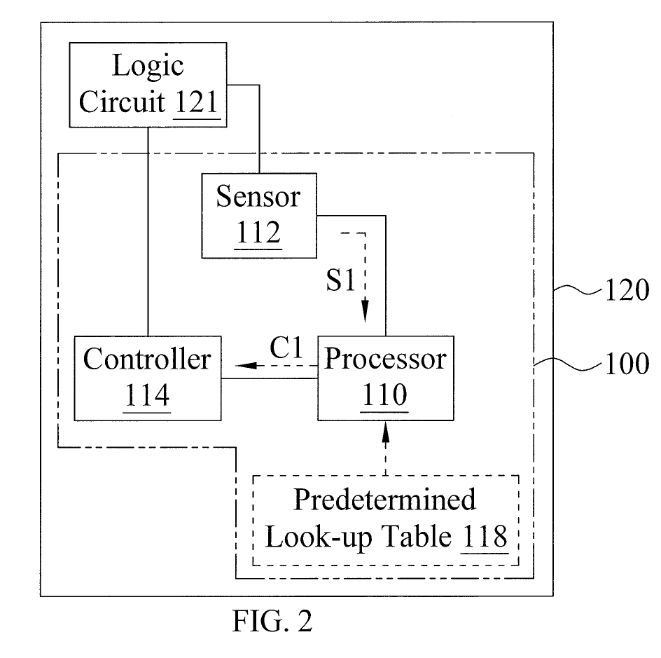

FIG. 2 is a schematic diagram of a system on chip of one embodiment of the present disclosure comprising a voltage and frequency scaling apparatus. As shown in the diagram, the voltage and frequency scaling apparatus 100 includes a processor 110, a sensor 112, and a controller 114. The sensor 112 is electrically coupled to the processor 110. The sensor 112 may, for example, measure at least one device characteristic of the logic circuit 121 of a system on chip 120 and transmit at least one sensing result S1 to the processor 110. The processor 110 generates a control signal C1 based on the at least one sensing result S1. The controller 114 is electrically coupled to the processor 110 and the logic circuit 121; the controller 114 receives the control signal C1 and adjusts at least one of the operating frequency and the operating voltage of the logic circuit 121.

The aforementioned “measurement” refers to an estimate or determination of a physical quantity, and not merely monitoring by a software method (without a quantitative measurement). In particular, the aforementioned “measurement” is a sensing measurement on measurable physical quantities, such as temperature, voltage, transistor speed and others. By using the sensor 112 to measure the device characteristics of the logic circuit 121 of a system on chip 120, the current functioning condition of the logic circuit 121 can be faithfully and immediately transmitted to the processor 110, so that the processor 110 may issue signals based on the actual operation performance of the logic circuit 121 to the controller 114, which then adjusts, as appropriate, at least one of the operating frequency and the operating voltage of the logic circuit 121.

In further detail, the processor 110 may instantly receive the sensing result S1 measured by the sensor 112 and respond by outputting a control signal C1. In one embodiment, the processor 110 may generate the control signal C1 based on the predetermined look-up table 118. During implementation, the predetermined look-up table 118 may comprise data of voltage/frequency corresponding to at least one device characteristic of the logic circuit 121. For example, the predetermined look-up table 118 may comprise multiple sets of voltage, temperature and speed characteristics of the logic circuit 121; with each set of voltage, temperature and speed characteristics having corresponding voltage/frequency data. After the processor 110 receives the sensing result S1, the processor 110 can determine the appropriate operating frequency/voltage of the logic circuit 121 based on the sensing result S1 and the predetermined look-up table 118, and then respond by outputting the control signal C1.

In some embodiments, the processor 110 can also generate the control signal C1 to control the logic circuit 121 through other methods, for example, by using algorithms to calculate the appropriate operating voltage/frequency range for the logic circuit 121 at the time. In this scenario, the processor 110 does not generate the control signal C1 based on the predetermined look-up table 118.

The following also refers to FIG. 2. The controller 114 may receive the control signal C1 and adjust at least one of the operating frequency and the operating voltage of the logic circuit 121. Therefore, by using the sensing result S1 generated by the sensor 112, the processor 110 no longer relies on the performance of the logic circuit 121 as estimated at the design stage to determine the operation range for the logic circuit 121. Instead, the processor 110 determines an appropriate operation range for the logic circuit 121 based on the actual operation performance of the logic circuit 121, the logic circuit 121 being integrated into the system on chip 120. In other words, when the logic circuit 121 is affected by process variation or by other components (such as in the case of voltage decay), the processor 110 is able to accurately determine the appropriate operation range for the logic circuit 121. Therefore, the voltage and frequency scaling apparatus of the present embodiment is able to optimize the performance of the logic circuit 121.

In the aforementioned one or multiple embodiments, the logic circuit 121 of the present disclosure may, for instance, be (but is not limited to) a central processing unit, a graphics processing unit, a physical layer (PHY) chip, wherein the physical layer chip may be, for example, an port physical layer (PHY) chip, a double data rate physical layer (DDR PHY) chip, or others. In other embodiments, the logic circuit 121 may be another type of intellectual property core (IP core).

In the aforementioned one or multiple embodiments, the device characteristics of the logic circuit 121 of the present disclosure may, for instance, be (but is not limited to) voltage, temperature, and speed characteristics. Whatever device characteristics that can be measured shall all belong to the scope of the present disclosure.

In the aforementioned one or multiple embodiments, the sensor 112 of the present disclosure may, for instance, be (but is not limited to) a voltage sensor, a temperature sensor, and a speed sensor. The choice of sensor for the sensor 112 may be changed depending on the type of logic circuit 121 employed. For example, the CPU and the graphics processor are operated at high speed, large area and high power. Therefore, a voltage sensor, a temperature sensor, and a speed sensor may all be installed to measure the device characteristics of the central processing unit and the graphics processing unit. In another example, the port PHY chip and the DDR PHY chip may be measured by installing a speed sensor only, in order to detect the speed characteristics thereof, such as cell delay time, rise time, fall time, and saturation current (Iₛₐₜ). In the aforementioned one or multiple embodiments, the device characteristics of the logic circuit 121 of the present disclosure may, for instance, be (but is not limited to) a voltage sensor, a temperature sensor, and a speed sensor.

In the aforementioned one or multiple embodiments, the controller 114 may comprise relevant circuits of clock management and/or voltage management. That is, the controller 114 may be electrically coupled to the clock gate or the power gate of the logic circuit 121 in order to adjust at least one of the operating frequency and the operating voltage of at least one logic circuit based on the control signal C1 of the processor 110.

In the aforementioned one or multiple embodiments, the predetermined look-up table 118 may be stored in the memory unit (not shown in the diagram) in advance, so that the processor 110 can quickly store data to or retrieve data from the predetermined look-up table 118. For example, the predetermined look-up table 118 may be stored within read-only memory (ROM), dynamic random access memory (DRAM), static random access memory (SRAM) or electronic fuse (e-fuse).

In the aforementioned one or multiple embodiments, the processor 110 may, for instance, be a microprocessor to control or adjust at least one of the operating frequency and the operating voltage of other logic circuits 121.

In the aforementioned one or multiple embodiments, the system on chip 120 may be a system on chip that integrates multiple kinds of key components, such as memory, microcontroller, digital signal processor, radio frequency chip, and reduced instruction set microprocessor memory. The system on chip 120 may be applied to electronic devices including laptop computers, desktop computers, smartphones, digital cameras, and tablet computers.

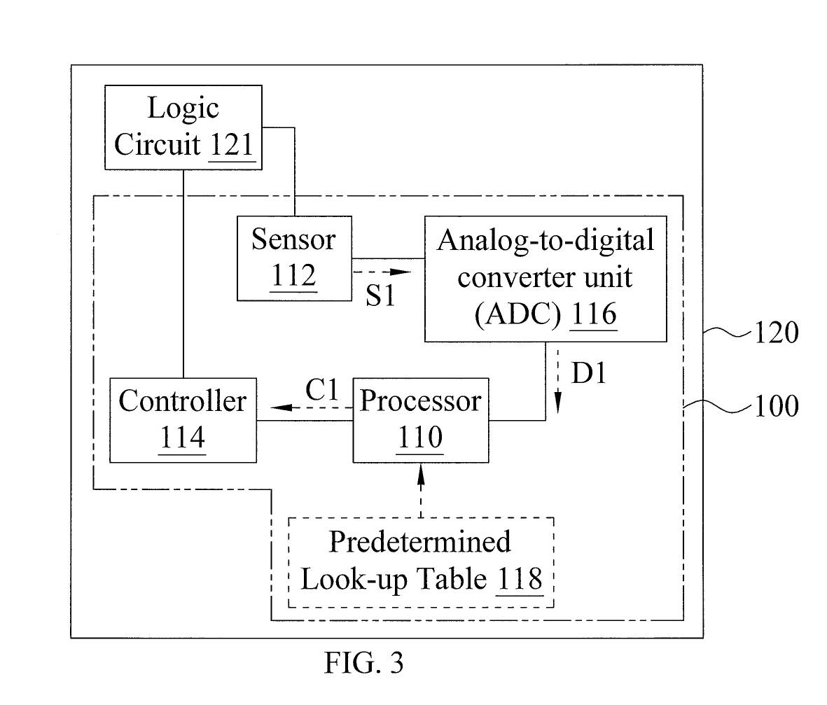

FIG. 3 is a schematic diagram of a system on chip of another embodiment of the present disclosure comprising a voltage and frequency scaling apparatus. As shown in the diagram, the difference between the embodiment in FIG. 3 and the embodiment in FIG. 2 is that the embodiment in FIG. 3 further comprises an analog-to-digital converter unit 116. The analog-to-digital converter unit 116 is electrically coupled to the processor 110 and the sensor 112, and is used to convert the sensing result S1 into a digital signal D1. If the sensing result S1 transmitted by the sensor 112 is an analog signal, the analog signal may be converted into a digital signal D1 by the analog-to-digital converter unit 116, so that the processor 110 can determine at least one of the operating frequency and the operating voltage of the logic circuit 121 precisely and quickly.

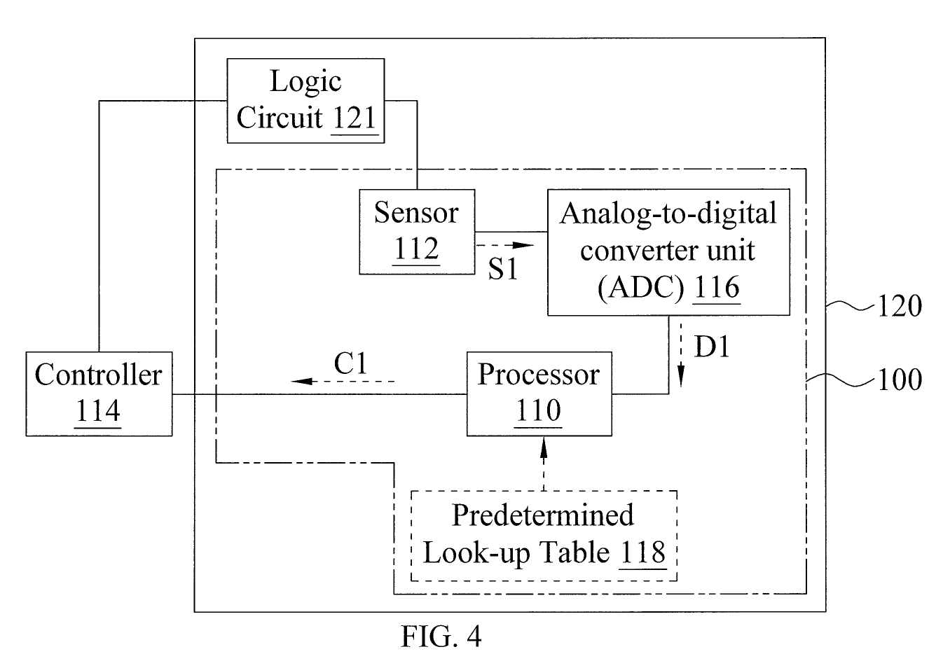

FIG. 4 is a schematic diagram of a system on chip and a voltage and frequency scaling apparatus of one embodiment of the present disclosure. What makes the embodiment in FIG. 4 different from the embodiment in FIG. 2 and the embodiment in FIG. 3 is that the controller 114 of the embodiment in FIG. 4 is located off-chip. In other words, the controller 114 is not in the system on chip 120. The processor 110 adjusts the at least one of the operating frequency and the operating voltage of the logic circuit 121 through the controller 114 installed outside the system on chip 120. This aspect of this embodiment can be applied to logic circuits 121 that do not have DVFS technology, so that for certain logic circuits 121 integrated onto the system on chip 120, when there is a need to adjust the voltage/frequency, the at least one of the operating frequency and the operating voltage of the logic circuit 121 can be adjusted using the off-chip mode.

Therefore, it is understood that in the embodiment of FIG. 4, the analog-to-digital converter unit 116 may be selectively installed according to what is required. For example, if the signal of the sensor 112 is an analog signal, the analog-to-digital converter unit 116 can help the processor 110 to interpret the sensing result S1. Thus, the analog-to-digital converter unit 116 is not an essential component. Besides, the sensor 112 may already be installed in the logic circuit 121. During manufacture of the system on chip 120, the sensor 112 is simply connected to the processor 10, and there is no need to install an additional sensor 112 in the voltage and frequency scaling apparatus 100.

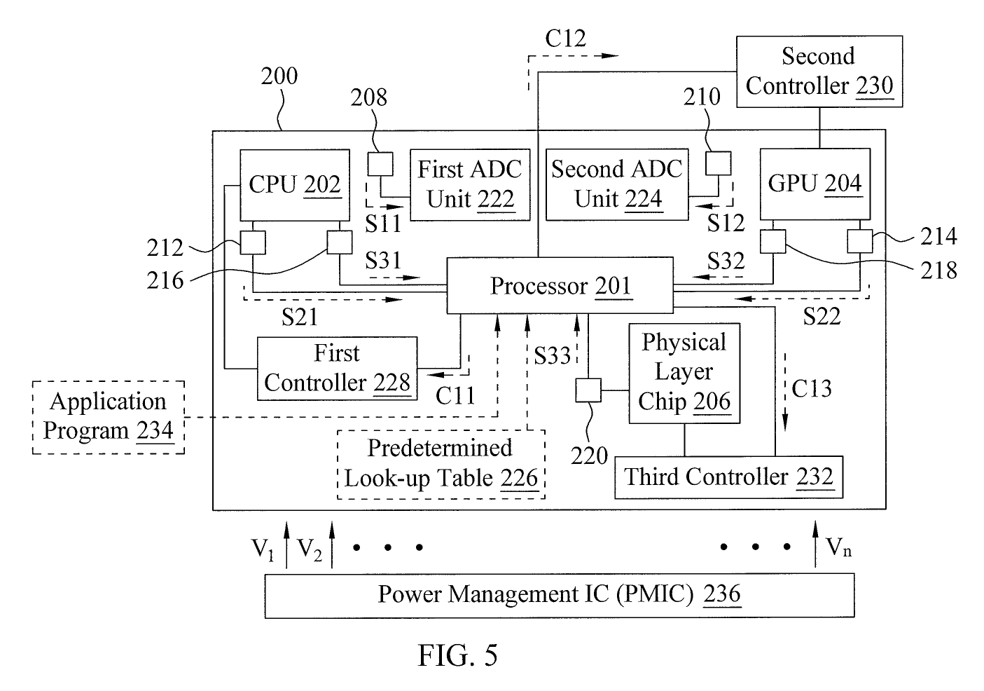

FIG. 5 shows the implementation details of a system on chip based on the voltage and frequency scaling apparatuses of the embodiments of the present disclosure illustrated in FIGS. 2 to 4. As shown in the diagram, the system on chip 200 includes a central processing unit 202, a graphics processing unit 204, and a physical layer chip 206. The central processing unit 202 and the graphics processing unit 204 are high speed intellectual property cores and are operated with large area and at high power. Therefore, the central processing unit 202 and the graphics processing unit 204 require sensing of speed, voltage, and temperature. The physical layer chip 206 is used to transfer information and requires sensing of speed.

The following refers to FIG. 5. The system on chip 200 includes a plurality of sensors including, for example, a first temperature sensor 208 and a second temperature sensor 210, a first voltage sensor 212, a second voltage sensor 214, a first speed sensor 216, a second speed sensor 218, and a third speed sensor 220. The first temperature sensor 208 and the second temperature sensor 210 are installed near the central processing unit 202 and the graphics processing unit 204 to sense the operation temperatures of the central processing unit 202 and the graphics processor 204 respectively and to generate the first sensing result S11 and the first sensing result S22 corresponding to the temperature characteristics of the central processing unit 202 and the graphics processing unit 204 respectively. The first voltage sensor 212 and the second voltage sensor 214 are electronically coupled to the central processing unit 202 and the graphics processor 204 respectively, in order to detect the operating voltages of the central processing unit 202 and the graphics processor 204 and to generate the second sensing result S21 and the second sensing result S22 respectively. The first speed sensor 216, the second speed sensor 218 and the third speed sensor 220 are electrically coupled to the central processing unit 202, the graphics processor 204 and the physical layer chip 206 respectively, to generate the third sensing result S31, the third sensing result S32, and the third sensing result S33 respectively.

The following also refers to FIG. 5. In some embodiments, the system on chip 200 may further include a first analog-to-digital converter (ADC) unit 222 and a second ADC unit 224. The first ADC unit 222 is electrically coupled to the first temperature sensor 208 and the processor 201; the second ADC unit 224 is electrically coupled to the second temperature sensor 210 and the processor 201. The first ADC unit 222 and the second ADC 224 can convert the analog signals generated respectively by the first temperature sensor 208 and the second temperature sensor 210 into digital signals for the processor 201 to determine the first sensing results of S11 and S22 quickly and accurately. Use of the ADC unit is not limited to the first temperature sensor 208 and the second temperature sensor 210, as in other embodiments the ADC unit may be used to convert analog signals from other types of sensors. Besides, in some embodiments, the processor 201 may also directly interpret the analog signals received. In other words, the first ADC unit 222 and the second ADC unit 224 may be selectively installed and are not essential components.

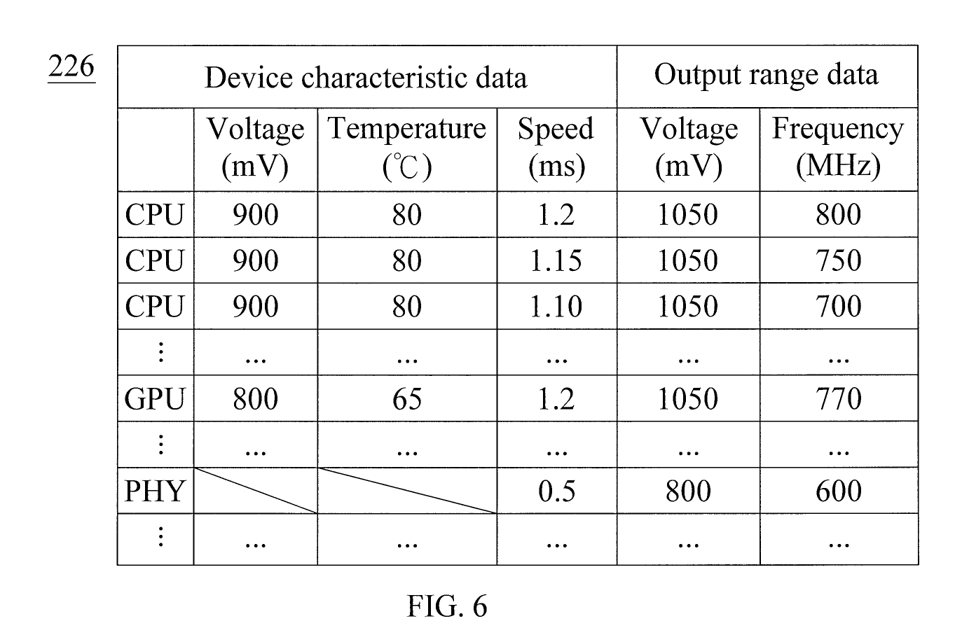

The processor 201 receives the sensing results from every sensor and generates control signals based on the predetermined look-up table 226. The following refers to FIG. 6, which is an example of a predetermined look-up table 226 of the embodiment illustrated in FIG. 5. As shown in FIG. 6, the predetermined look-up table 226 includes multiple sets of data of characteristics of the central processing unit (CPU) 202, the graphics processing unit (GPU) 204, and the physical Layer (PHY) chip 206, such as the characteristics of voltage (millivolt, mV), temperature (Celsius, ° C.), and speed (millisecond, ms), wherein the speed characteristics, for instance, delay time represents the delay time of a component in a chip (for example, an inverter in a ring-shaped oscillator). The predetermined look-up table 226 also includes data for each range, that is the voltage (millivolt, mV) and frequency (MHz) data corresponding to each voltage, temperature, and speed characteristics respectively.

In one embodiment, when the processor 201 receives the relevant first sensing result S11, the second sensing result S21, and the third sensing result S31 respectively from the first temperature sensor 208, the first voltage sensor 212, and the first speed sensor 216 for the central processing unit 202, then the processor 201 compares the first sensing result S11, the second sensing result S21, and the third sensing result S31 with the device characteristics in the predetermined look-up table 226 to determine if a match is found. If a match with the data of the device characteristics is identified, the processor 201 then generates a first control signal C11 based on the data of range corresponding to the identified device characteristics, in order to control the operating voltage and/or the operating frequency of the central processing unit 202.

During such implementation, if there is no match of the first sensing result S11, the second sensing result S21, and the third sensing result S31 with the device characteristics in the predetermined look-up table 226, then the processor 201 can still determine the output range. For example, if the processor 201 receives the voltage/temperature/speed data according to the first sensing result S11, the second sensing result S21, and the third sensing result 531, as 900 mV/80° C./1.18 ms, the processor 201 will select the output range of 1050 mV/750 MHz corresponding to the device characteristic data of 900 mV/80° C./1.15 ms, and use 1050 mV/750 MHz as the operating voltage/frequency of the central processing unit 202, in order to prevent the frequency of the central processing unit 202 from becoming too fast and the central processing unit 202 from overheating.

In the aforementioned one or multiple embodiments, the predetermined look-up table 118 or the predetermined look-up table 226 may be established in, but is not limited to, the memory (not shown in the diagrams) based on data produced from voltage and frequency experiments and adjustments by the chip development engineers. In other embodiments, the predetermined look-up table 118 or the predetermined look-up table 226 may also be established in advance according to the user's judgment on the data to be stored in the memory.

The following also refers to FIG. 5. Based on the first sensing results S11 and S12, the second sensing results S21 and S22, and the third sensing results S31, S32 and S33, the processor 201 may generate the first control signal C11, the second control signal C12, and the third control signal C13 respectively. The first control signal C11, the second control signal C12, and the third control signal C13 may be separately fed to the first controller 228, the second controller 230 and the third controller 232 respectively. The first controller 228, the second controller 230 and the third controller 232 may independently control the operating voltage and/or the operating frequency of the central processing unit 202, the graphics processing unit 204 and the physical layer chip 206 respectively, wherein the second controller 230 may be installed outside the system on chip 200, like the off-chip architecture described in the embodiment in FIG. 4.

The following also refers to FIG. 5. In some embodiments the processor 201 may monitor the usage conditions of the central processing unit 202, the graphics processing unit 204 and the physical layer chip 206 through an application program 234, like the example described in FIG. 1. In other words, the voltage and frequency scaling apparatus 100 disclosed in FIGS. 2 to 4 of the present disclosure has no conflict with the use of software monitoring methods (through the application program 234). However, if the user instructs, through the application program 234, an operating voltage and/or the operating frequency which may overload the operations of the central processing unit 202, the graphics processing unit 204 or the physical layer chip 206, then the voltage and frequency scaling apparatus 100 of the present disclosure has precedence to adjust the operating voltage and/or the operating frequency of the central processing unit 202, the graphics processing unit 204 and the physical layer chip 206. For example, if the user's instruction causes the central processing unit 202 to reach the condition of over-frequency, when the first temperature sensor 208 detects a high temperature, the processing unit 201 has precedence and intervenes to lower the frequency of the central processing unit 202.

In addition, in some embodiments, when the user increases the operating frequency of a specific logic circuit 121 through the application program 234, such as the increase of operating frequency of the central processing unit 202, then the processor 201 can predict, through an internal calculation mechanism, that the temperature of the central processing unit 202 will definitely increase. Therefore, the processor 202 can determine in advance the appropriate range for the central processing unit 202 through the predetermined look-up table 226, in order to optimize or maximize the performance of the central processing unit 202.

The following also refers to FIG. 5. In some embodiments the system on chip 200 can provide multiple sets of initial voltages V1, V2, Vn for the system on chip 200 through a power management IC (PMIC) 236, in order to drive different logic circuits 121 within the system on chip 200, such as the central processing unit 202, the graphics processing unit 204, the physical layer chip 206, the processor 201, and the memory unit (not shown in the diagram). In one embodiment, the power management IC (PMIC) 236 can be integrated into the system on chip 200.

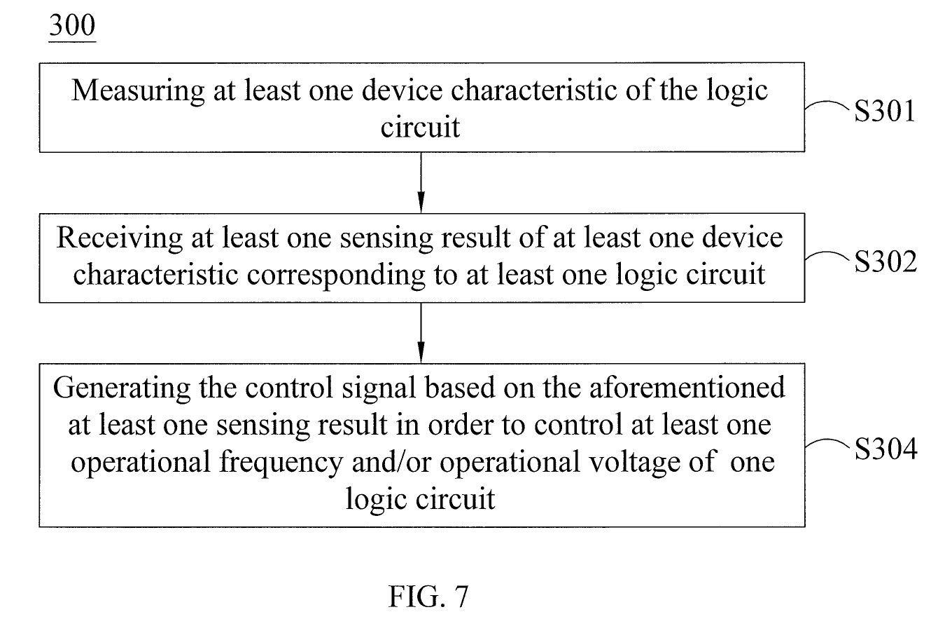

FIG. 7 is a flow chart of a voltage and frequency scaling method of one embodiment of the present disclosure. The voltage and frequency scaling method may be used to adjust the voltage and/or the frequency of at least one logic circuit 121 of the system on chip 120 or the system on chip 200. For example, for the implementations of the system on chip 120 or the system on chip 200 shown in FIGS. 2 to 5, the voltage and frequency scaling method 300 is described as follows.

In step 302, receiving at least one sensing result of at least one device characteristic corresponding to at least one logic circuit 121. In step 304, generating the control signal based on the aforementioned at least one sensing result in order to control at least one operating frequency and/or operating voltage of one logic circuit 121. With reference to FIGS. 2 to 5, steps 302 and 304 may be implemented through one or multiple processors 110 or processors 201.

In some embodiments, the number of at least one sensing result is plurality and the voltage and frequency scaling method 300 may further include step 301: measuring at least one device characteristic of the logic circuit 121. The device characteristics may, for example, include (but are not limited to) temperature characteristics, voltage characteristics and/or speed characteristics. With reference to FIGS. 2 to 5, step 301 may be implemented through, but is not limited to, the sensor 112, which may be for example, temperature, voltage, or speed sensors.

In some embodiments, step 304 that generates the control signal may further include the following step: generating the control signal Cl according to a predetermined look-up table 118 or a predetermined look-up table 226. The following refers to FIG. 6. The predetermined look-up table 226 may include data of voltage/frequency corresponding to the voltage characteristics, the temperature characteristics, and speed characteristics of each logic circuit 121.

In summary, one or multiple embodiments of the present disclosure disclose multiple implementation aspects of the voltage and frequency scaling apparatus in the system on chip and the method thereof. More specifically, the aforementioned one or multiple embodiments measure the device characteristics of the logic circuit through the embedded sensors, so that the processor can provide at least one appropriate operating frequency and operating voltage based on the performance of the logic circuit in the system on chip. On the other hand, the method of using only software to adjust at least one of the operating frequency and the operating voltage of the logic circuit can not acquire the device characteristics, for example, the temperature, voltage, speed of the logic circuit in the system on chip, and therefore can only adopt a more conservative method to adjust at least one of the operating frequency and the operating voltage to avoid overheating. Therefore, one or multiple embodiments of the voltage and frequency scaling apparatus in the system on chip and the method thereof disclosed in the present disclosure can further optimize the performance of the logic circuit.

In various embodiments, the processor 11, 110 and 201 may be a uniprocessor system or a multiprocessor system having several processing cores. For instance, the processor 11, 110 and 201 may include two, four, eight, or any appropriate number of cores. In an embodiment the processor 11, 110 and 201 may be a general purpose processor or embedded processor that implement any of a variety of instruction set architectures (ISAs), e.g. the x86, PowerPC, SPARC, or MIPS ISAs, or any other suitable ISAs known to the person skilled in the art. In multiprocessor systems, each of the processing cores of the processor 11, 110 and 201 may commonly implement the same ISA, but not limited thereto.

In accordance with the embodiments of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method including a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The methods described herein may be implemented in software, hardware, or a combination thereof. In addition, parts of the steps of the method may be changed and various elements may be added, recorded combined, omitted, modified, etc. While the means of specific embodiments in present disclosure has been described by reference drawings, numerous modifications and variations could be made thereto by those skilled in the art without departing from the scope and spirit of the invention set forth in the claims. The modifications and variations should in a range limited by the specification of the present disclosure.

The aforementioned descriptions are for illustration only and shall not be interpreted to limit the scope, applicability or configuration, of the present disclosure in any way. Any alternative embodiments that include modifications or changes without departing from the spirit and scope of the present disclosure shall be included in the appended claims.

What is claimed is:

1. A voltage and frequency scaling apparatus, comprising a processor;
at least one sensor, electrically coupled to the processor, wherein the at least one sensor is configured for measuring at least one device characteristic of at least one logic circuit of a system on chip and outputs at least one sensing result to the processor, the processor generating a control signal based on the at least one sensing result; and
a controller configured to receive the control signal and adjusts at least one of the operating frequency and the operating voltage of the at least one logic circuit based on at least the control signal.

2. The voltage and frequency scaling apparatus as claimed in claim 1 further comprising:
an analog-to-digital converter unit that is electrically coupled to the processor and the sensor and that is configured to convert the sensing result into a digital signal.

3. The voltage and frequency scaling apparatus as claimed in claim 1, wherein the at least one device characteristic includes at least one of the voltage characteristic, the temperature characteristic, and the speed characteristic.

4. The voltage and frequency scaling apparatus as claimed in claim 1, wherein the at least one sensor includes at least one of a voltage sensor, a temperature sensor, and a speed sensor.

5. The voltage and frequency scaling apparatus as claimed in claim 1, wherein the processor compares the at least one sensing result with a predetermined look-up table in order to generate the control signal.

6. The voltage and frequency scaling apparatus as claimed in claim 5, wherein the predetermined look-up table includes data of voltage/frequency corresponding to at least one device characteristic of the at least one logic circuit.

7. A system on chip, comprising
at least one logic circuit;
at least one sensor configured for measuring at least one device characteristic of the at least one logic circuit and outputs at least one sensing result; and
a processor electrically coupled to the at least one sensor and configured for adjusting at least one of the operating frequency and the operating voltage of the at least one logic circuit based on the at least one sensing result.

8. The system on chip as claimed in claim 7, further comprising:
an analog-to-digital converter unit that is electrically coupled to the processor and the sensor and that is configured to convert the sensing result into a digital signal.

9. The system on chip as claimed in claim 7, wherein the at least one logic circuit includes at least one of a central processing unit, a graphics processing unit, and a physical layer (PHY) chip.

10. The system on chip as claimed in claim 9, wherein
the at least one logic circuit includes the central processing unit and the graphics processing unit;
the sensors includes a plurality of temperature sensors installed nearby the central processing unit and the graphics processing unit separately.

11. The system on chip as claimed in claim 9, wherein
the at least one logic circuit includes the central processing unit and the graphics processing unit;
the sensors includes a plurality of voltage sensors electrically coupled to the central processing unit and the graphics processing unit respectively.

12. The system on chip as claimed in claim 9, wherein
the at least one logic circuit includes the central processing unit, the graphics processing unit, and the physical layer chip;
the sensors includes a plurality of speed sensors, which are electrically coupled to the central processing unit, the graphics processing unit, and the physical layer chip respectively.

13. The system on chip as claimed in claim 7, wherein the at least one device characteristic includes at least one of a voltage characteristic, a temperature characteristic, and a speed characteristic.

14. The system on chip as claimed in claim 7, wherein the processor adjusts at least one of the operating frequency and the operating voltage of the at least one logic circuit through a controller.

15. The system on chip as claimed in claim 7, further comprising:
a controller electrically coupled to the processor and the at least one logic circuit, wherein the processor receives the sensing result and outputs a control signal, the controller receives the control signal and adjusts at least one of the operating frequency and the operating voltage of the at least one logic circuit.

16. The system on chip as claimed in claim 15, wherein the processor generates the control signal based on a predetermined look-up table.

17. The system on chip as claimed in claim 16, wherein the predetermined look-up table comprises data of voltage/frequency corresponding to the at least one device characteristic of the at least one logic circuit.

18. A voltage and frequency scaling method for scaling the voltage and/or frequency of at least one logic circuit of the system on chip, where the voltage scaling method comprises:
receiving at least one sensing result of at least one device characteristic corresponding to the at least one logic circuit; and
generating a control signal based on the at least one sensing result for controlling at least one of the operating frequency and the operating voltage of the at least one logic circuit.

19. The voltage and frequency scaling method as claimed in claim 18 further comprising:
measuring at least a temperature characteristics, a voltage characteristics and a speed characteristics of the logic circuit; and
generating a first sensing result corresponding to the temperature characteristics, a second sensing result corresponding to the voltage characteristics, and a third sensing result corresponding to the speed characteristics.

20. The voltage and frequency scaling method as claimed in claim 19, wherein the steps of generating the control signal further comprise:
generating the control signal based on a predetermined look-up table, wherein the predetermined look-up table includes data of voltage/frequency corresponding to the voltage characteristics, the temperature characteristics, the speed characteristics of the at least one logic circuit.
